(19) United States
(12) Patent Application Publication
(10) Pub. No.: US 2003/0153677 A1
(43) Pub. Date: Aug. 14, 2003

(54) Impact-resistance modified polymer compositions

(76) Inventors: Holger Warth, Dormagen (DE); Gerwolf Quass, Koln (DE); Dieter Wittmann, Leverkusen (DE)

Correspondence Address: BAYER POLYMERS LLC, 100 BAYER ROAD, PITTSBURGH, PA, 15205, US

(21) Appl. No.: 10/276,578

(22) PCT Filed: May 7, 2001
(86) PCT No.: PCT/EP01/05137

(30) Foreign Application Priority Data
May 19, 2000 (DE) 100 24 935.3
May 19, 2000 (DE) 100 24 933.7
Feb. 26, 2001 (DE) 101 09 225.3

(51) Int. Cl. C08L 51/00

(52) U.S. Cl. 525/66

(57) ABSTRACT

An impact resistance-modified polymer composition containing

(A) at least one polyamide,

(B) at least one graft copolymer, wherein the graft substrate is based on a diene rubber,

(C) at least one compatibility promoter,

(D) at least one vinyl copolymer and

(E) very finely divided mineral particles with anisotropic particle geometry

and moulded items produced therefrom.

The invention relates to impact resistance-modified polymer compositions, in particular impact resistance-modified polyamide compositions and moulded items produced therefrom.

Polymer blends consisting of a polyamide, a styrene/acrylonitrile copolymer and a compatibility promoter are known from EP 0 202 214 A. The compatibility promoter used is a copolymer consisting of a vinyl aromatic monomer and acrylonitrile, methacrylonitrile, C₁ to C₄ alkyl methacrylate or C₁ to C₄ alkyl acrylate in a ratio by weight of 85:15 to 15:85. An increased impact resistance should be achieved by the use of compatibility promoters. The disadvantage of the polymer blends described in that document is that they have too low a rigidity and too high a coefficient of expansion for thin walled applications.

The use of finely divided inorganic materials in specific polymer compositions, in particular in polycarbonate compositions, is also generally known. The inorganic materials are used in these compositions, for example, as reinforcement agents to increase the rigidity and tensile strength, to increase the dimensional stability under varying temperature conditions, to improve the surface properties or, in flame resistant materials, also as synergistic flame retardants. Either mineral or else artificially obtained materials are used. Thus, in U.S. Pat. No. 5,714,537, for example, polycarbonate blends are described which contain specific inorganic fillers to improve the rigidity and linear coefficient of thermal expansion.

Furthermore, DE 39 38 421 A1 describes moulding compositions consisting of polyamides and graft polymers containing specific tert.-alkyl esters. Although these polymers have a high gloss on the surface and good dimensional stability, further improvement in impact resistance, such as is required for thin walled applications, would be desirable.

EP 0 785 234 A1 discloses rubber-modified polymer compositions which contain a terpolymer of styrene, acrylonitrile and maleic anhydride as compatibility promoter. The addition of compatibility promoters leads to an improvement in mechanical properties, in particular impact resistance at low temperatures. However, the disadvantage is that the overall properties of the polymer, in particular the processing behaviour during injection moulding, suffers with addition of the compatibility promoter.

The invention is thus based on the object of providing polyamide compositions with reduced coefficients of expansion and increased tensile strength which also have good processing behaviour.

This object is achieved by a polymer composition containing

(A) at least one polyamide,

(B) at least one graft copolymer,

(C) at least one compatibility promoter,

(D) at least one vinyl (co)polymer, and

(E) very finely divided mineral particles with anisotropic particle geometry.

Surprisingly, it was found that a particularly balanced set of properties can be achieved by the simultaneous use of (a) compatibility promoters on the one hand and (b) very finely divided mineral particles with anisotropic particle geometry on the other hand in impact resistance-modified polyamide compositions. In particular, polyamide compositions in accordance with the invention have a considerably reduced coefficient of expansion and an increased tensile and tear strength and simultaneously have outstanding melt volume rates. In addition, moulded items produced from compositions according to the invention have exceptional surface properties and extremely low abrasion, even in thin walled applications.

Special features of the invention include the fact that specific mineral particles are used as component E in the composition. These are characterised, as explained below in detail, by anisotropic particle geometry. According to the invention, particles with anisotropic particle geometry are understood to be those particles in which the so-called aspect ratio, i.e. the ratio of the largest to the smallest particle dimension, is greater than 1, preferably greater than 2 and particularly preferably greater than about 5. These types of particles are, in the widest sense, shaped like plates or fibres.

It is assumed that there is a synergistic interaction between components C (compatibility promoter) and E (mineral particle with anisotropic particle geometry) which improves the impact resistance.

Components suitable for use in a polymer composition according to the invention are described by way of example in the following.

Component A

Polyamides (component A) which are suitable according to the invention are known or can be prepared by processes disclosed in the literature.

Polyamides which are suitable according to the invention are known homopolyamides, copolyamides and mixtures of these polyamides. These may be partially crystalline and/or amorphous polyamides. Suitable partially crystalline polyamides are polyamide-6, polyamide-6,6 and mixtures and corresponding copolymers of these components. Furthermore, suitable partially crystalline polyamides are those in which the acid component consists entirely or partly of terephthalic acid and/or isophthalic acid and/or suberic acid and/or sebacic acid and/or azelaic acid and/or adipic acid and/or cyclohexane dicarboxylic acid, in which the diamine component consists entirely or partly of m- and/or p-xylylene diamine and/or hexamethylene diamine and/or 2,2,4-trimethylhexamethylene diamine and/or 2,4,4-trimethylhexamethylene diamine and/or isophorone diamine and the compositions of which are known in principle.

In addition, polyamides may be mentioned which are prepared entirely or partly from lactams with 7 to 12 carbon atoms in the ring, optionally also using one or more of the starting compounds mentioned above.

Particularly preferred partially crystalline polyamides are polyamide-6 and polyamide-6,6 and their mixtures. Known products may be used as amorphous polyamides. They are obtained by polycondensation of diamines such as ethylene diamine, hexamethylene diamine, decamethylene diamine, 2,2,4- and/or 2,4,4-trimethylhexamethylene diamine, m- and/or p-xylylene diamine, bis-(4-aminocyclohexyl)-methane, bis-(4-amino-cyclohexyl)-propane, 3,3′-dimethyl-4,4′-diaminodicyclohexylmethane, 3-aminomethyl-3,5,5-trimethylcyclohexylamine, 2,5-and/or 2,6-bis-(aminomethyl)-norbomane and/or 1,4-diaminomethylcyclohexane with dicarboxylic acids such as oxalic acid, adipic acid, azelaic acid, decanedicarboxylic acid, heptadecanedicarboxylic acid, 2,2,4- and/or 2,4,4-trimethyladipic acid, isophthalic acid and terephthalic acid.

Copolymers which are obtained by polycondensation of several monomers are also suitable; furthermore, copolymers which are prepared with the addition of aminocarboxylic acids such as ε-aminocaproic acid, ω-aminoundecanoic acid or ω-aminolauric acid or their lactams.

Particularly suitable amorphous polyamides are the polyamides prepared from isophthalic acid, hexamethylene diamine and other diamines such as 4,4′-diamino-dicyclohexylmethane, isophorone diamine, 2,2,4- and/or 2,4,4-trimethylhexamethylene diamine, 2,5- and/or 2,6-bis-(aminomethyl)-norbornene; or from isophthalic acid, 4,4′-diamino-dicyclohexylmethane and ε-caprolactam; or from isophthalic acid, 3,3′-dimethyl-4,4′-diamino-dicyclohexylmethane and lauryl lactam; or from terephthalic acid and the isomeric mixture of 2,2,4- and/or 2,4,4-trimethylhexamethylene diamine.

Instead of pure 4,4′-diaminodicyclohexylmethane, mixtures of the positional isomers of diaminodicyclohexylmethane may also be used which are composed of

| | |
|---|---|
| 70 to 99 mol % | of 4,4′-diamino isomer, |
| 1 to 30 mol % | of the 2,4′-diamino isomer and |
| 0 to 2 mol % | of the 2,2′-diamino isomer, |

optionally with the corresponding more highly condensed diamines which are obtained by hydrogenation of diaminodiphenylmethanes of technical grade quality. Up to 30% of the isophthalic acid may be replaced by terephthalic acid.

The polyamides preferably have a relative viscosity (measured in a 1 wt. % solution in m-cresol at 25° C.) of 2.0 to 5.0, particularly preferably 2.5 to 4.0.

The polyamides may be present in component A individually or in any mixture with each other.

Component A may preferably be present in the polymer composition according to the invention in an amount of 10 to 98 wt. %, in particular 15 to 70 wt. % and particularly preferably 20 to 60 wt. %, with respect to the composition.

Component B

Component B contains one or more rubber-modified graft polymers. Rubber-modified graft polymer B contains a statistical (co)polymer of monomers in accordance with B.1.1 and B. 1.2, and also a rubber B.2 grafted with the statistical (co)polymer of B.1.1 and B.1.2, wherein B may be prepared in a known manner by a bulk or solution or bulk-suspension polymerisation process, as described, for example, in U.S. Pat. No. 3,243,481, U.S. Pat. No. 3,509,237, U.S. Pat. No. 3,660,535, U.S. Pat. No. 4,221,833 and U.S. Pat. No. 4,239,863.

Examples of monomers B.1.1 are styrene, α-methylstyrene, halogen or alkyl ring-substituted styrenes such as p-methylstyrene, p-chlorostyrene, C₁-C8-alkyl (meth)acrylates such as methyl methacrylate, n-butyl acrylate and tert.-butyl acrylate. Examples of monomers B.1.2 are unsaturated nitriles such as acrylonitrile, methacrylonitrile, C₁-C₈-alkyl (meth)acrylates such as methyl methacrylate, n-butyl acrylate, tert.-butyl acrylate, derivatives (such as anhydrides and imides) of unsaturated carboxylic acids such as maleic anhydride and N-phenyl-maleic imide or mixtures thereof.

Preferred monomers B.1.1 are styrene, a-methylstyrene and/or methyl methacrylate, preferred monomers B.1.2 are acrylonitrile, maleic anhydride and/or methyl methacrylate.

Particularly preferred monomers are B.1.1 styrene and B.1.2 acrylonitrile.

Rubbers B.2 suitable for the rubber-modified graft polymers B are, for example, diene rubbers, EP(D)M rubbers, that is those based on ethylene/propylene and optionally diene, acrylate, polyurethane, silicone, chloroprene and ethylene/vinyl acetate rubbers.

Preferred rubbers B.2 are diene rubbers (e.g. based on butadiene, isoprene, etc.) or mixtures of diene rubbers or copolymers of diene rubbers or their mixtures with other copolymerisable monomers (e.g. in accordance with B.1.1 and B.1.2), with the proviso that the glass transition temperature of component B.2 is below 10° C., preferably below −10° C. Particularly preferred is pure polybutadiene rubber. Up to 50 wt. %, preferably up to 30 wt. %, in particular up to 20 wt. % (with respect to rubber substrate B.2) of other copolymerisable monomers may be present in the rubber substrate.

Component B may, if required and if this does not impair the rubber properties of component B.2, may also contain small amounts, generally less than 5 wt. %, preferably less than 2 wt. %, with respect to B.2, of cross-linking ethylenically unsaturated monomers. Examples of such cross-linking monomers are alkylenediol-di(meth)acrylates, polyester-di(meth)acrylates, divinylbenzene, trivinylbenzene, triallyl cyanurate, allyl (meth)acrylate, diallyl maleate and diallyl fumarate.

Rubber-modified graft polymer B is obtained by graft polymerisation of 50 to 99, preferably 65 to 98, particularly preferably 75 to 97 parts by wt. of a mixture of 50 to 99, preferably 60 to 95 parts by wt. of monomers in accordance with B.1.1 and 1 to 50, preferably 5 to 40 parts by wt. of monomers in accordance with B. 1.2 in the presence of 1 to 50, preferably 2 to 35, particularly preferably 2 to 15, in particular 2 to 13 parts by wt. of rubber component B.2, wherein graft polymerisation is performed by a bulk or solution or bulk-suspension polymerisation process.

It is essential, during preparation of the rubber-modified graft polymer B, that the rubber component B.2 is present in the dissolved form prior to graft polymerisation in the mixture of monomers B.1.1 and B.1.2. The rubber component B.2 must therefore not be so strongly cross-linked that dissolution in B.1.1 and B.1.2 is impossible and also B.2 should not be present in the form of discrete particles at the beginning of the graft polymerisation procedure. The particle morphology and increasing cross-linking of B.2 which are important for the product properties of B are produced only during the course of graft polymerisation (on this point, see, for example, Ullmann, Encyclopadie der technischen Chemie, vol. 19, p. 284 et seq., 4th edition, 1980).

Some of the statistical copolymer of B.1.1 and B.1.2 is normally present in polymer B on rubber B.2 or grafted therein, wherein this graft mixed polymer forms discrete particles in polymer B. The proportion of copolymer of B.1.1 and B.1.2 in the entire copolymer of B.1.1 and B.1.2 which is grafted on or in, that is the graft yield (=proportion by wt. of actually grafted graft monomers to the total amount of graft monomers used×100, given as a %), should be 2 to 40%, preferably 3 to 30%, particularly preferably 4 to 20%.

In the context of the present invention, graft polymer B is understood to be the product of grafted rubber obtained during graft polymerisation and the (co)polymer produced during graft polymerisation. The amounts of (co)polymer inevitably produced during graft polymerisation depend, inter alia, on the monomer composition and the method of polymerisation. Since, depending on the type and amount of separately added (co)polymer D, this cannot be differentiated from the (co)polymer produced during polymerisation of the graft polymer, the sum of the amounts of components B and D are equal to the sum of the graft polymer and the (co)polymer.

The average particle diameter of the resulting grafted rubber particles (determined by counting on electron microscope images) is in the range 0.5 to 5 μm, preferably 0.8 to 2.5 μm.

The graft copolymers may be present in component B individually or in any mixture with each other.

Component B is preferably present in the polymer composition according to the invention in an amount of 0.5 to 80 wt. %, particularly preferably 1 to 60 wt. % and very particularly preferably 2 to 40 wt. %, in particular 8 to 40 wt. %, with respect to the composition.

Component C

According to the invention, thermoplastic polymers with polar groups are preferably used as compatibility promoters.

Thus, according to the invention, polymers are used which contain

C.1 a vinyl aromatic monomer,

C.2 at least one monomer chosen from the group C₂ to C₁₂ alkyl methacrylates, C₂ to C₁₂ alkyl acrylates, methacrylonitrile and acrylonitrile and

C.3 dicarboxylic acid anhydrides which contain α,β-unsaturated components.

Styrene is particularly preferably used as vinyl aromatic monomer C.1.

Acrylonitrile is particularly preferred as component C.2.

Maleic anhydride is particularly preferred as a dicarboxylic acid anhydride C.3 which contains α,β-unsaturated components.

Terpolymers of the monomers mentioned are preferably used as components C.1, C.2 and C.3. Thus, terpolymers of styrene, acrylonitrile and maleic anhydride are preferably used. These terpolymers contribute in particular to the improvement in mechanical properties, such as tensile strength and elongation at break. The amount of maleic anhydride in the terpolymer may vary between wide limits. The amount is preferably 0.2 to 5 mol %. Amounts between 0.5 and 1.5 mol % are particularly preferred. In this range, particularly good mechanical properties with regard to tensile strength and elongation at break are produced.

The terpolymer may be prepared in a manner known per se. A suitable method is dissolution of the monomer components in the terpolymer, e.g. styrene, maleic anhydride or acrylonitrile, in a suitable solvent, e.g. methyl ethyl ketone (MEK). To this solution are added one or optionally several chemical initiators. Suitable initiators are, for example, peroxides. Then the mixture is polymerised for several hours at elevated temperature. Finally, the solvent and unreacted monomers are removed in a manner known per se.

The ratio between component C.1 (vinyl aromatic monomer) and component C.2, e.g. the acrylonitrile monomer, in the terpolymer is preferably between 80:20 and 50:50. In order to improve miscibility of the terpolymer with the graft copolymer B, an amount of vinyl aromatic monomer C.1 is preferably chosen which corresponds to the amount of vinyl monomer B.1 in graft copolymer B.

Examples of compatibility promoters C which can be used according to the invention are described in EP-A 785 234 and EP-A 202 214. According to the invention, the polymers mentioned in EP-A 785 234 are particularly preferred.

The compatibility promoters may be present in component C individually or in any mixture with each other.

A further substance which is particularly preferred as a compatibility promoter is a terpolymer of styrene and acrylonitrile in the ratio by weight of 2.1:1 containing 1 mol % maleic anhydride.

The amount of component C in the polymer compositions according to the invention is preferably between 0.5 and 50 wt. %, in particular between 1 and 30 wt. % and particularly preferably between 2 and 10 wt. %, with respect to the composition. Most highly preferred are amounts between 5 and 7 wt. %.

Component D

Component D contains one or more thermoplastic vinyl (co)polymers.

Suitable vinyl (co)polymers for use as component D are polymers of at least one monomer from the group of vinyl aromatic compounds, vinyl cyanides (unsaturated nitrites), (C₁-C₈)-alkyl (meth)acrylates, unsaturated carboxylic acids and derivatives (such as anhydrides and imides) of unsaturated carboxylic acids. Particularly suitable are (co)polymers of

D.1 50 to 99, preferably 60 to 80 parts by wt. of vinyl aromatic compounds and/or ring-substituted vinyl aromatic compounds (such as styrene, α-methylstyrene, p-methylstyrene, p-chlorostyrene) and/or (C₁-C₈)-alkyl (meth)acrylates (such as methyl methacrylate, ethyl methacrylate), and

D.2 1 to 50, preferably 20 to 40 parts by wt. of vinyl cyanides (unsaturated nitrites) such as acrylonitrile and methacrylonitrile and/or (C₁-C₈)-alkyl (meth)acrylates (such as methyl methacrylate, n-butyl acrylate, tert.-butyl acrylate) and/or imides of unsaturated carboxylic acids (e.g. N-phenylmaleic imide).

(Co)polymers D are resinous, thermoplastic and rubber-free.

The copolymer of D.1 styrene and D.2 acrylonitrile is particularly preferred.

(Co)polymers D are known and can be prepared by radical polymerisation, in particular by emulsion, suspension, solution or bulk polymerisation. (Co)polymers preferably have average molecular weights Mw (weight average, determined by light scattering or sedimentation) between 15,000 and 200,000.

The vinyl (co)polymers may be present in component D individually or in any mixture with each other.

Component D is preferably present in the polymer composition in an amount of 0 to 80 wt. %, in particular 0 to 70 wt. % and particularly preferably 0 to 60 wt. %, in particular 5 to 40 wt. %, with respect to the composition.

Component E

Very finely divided mineral particles suitable for use according to the invention are those with anisotropic particle geometry.

According to the invention, mineral particles with anisotropic particle geometry are understood to be those particles in which the so-called aspect ratio, the ratio of the largest to the smallest particle dimension, is greater than 1, preferably greater than 2 and particularly preferably greater than about 5. These types of particles are, at least in the widest sense, shaped like plates or fibres. Included among such materials are, for example, certain talcs and certain (alumino)silicates with layered or fibrous geometry, such as bentonite, wollastonite, mica, kaolin, hydrotalcite, hectorite or montmorillonite.

Inorganic materials with a flaky or plate-like character are preferably used, such as talc, mica/clay layered minerals, montmorillonite, the latter also in an organophilic form modified by ion exchange, kaolin and vermiculite.

Talc is particularly preferred. Talc is understood to be a naturally occurring or synthetically prepared talc. Pure talc has the chemical composition 3MgO.4SiO₂.H₂O and thus has a MgO content of 31.9 wt. %, a SiO₂ content of 63.4 wt. % and a chemically bonded water content of 4.8 wt. %. It is a silicate with a sheet structure.

Types of talc with high purity are preferred. These have, for example, a MgO content of 28 to 35 wt. %, preferably 30 to 33 wt. %, particularly preferably 30.5 to 32 wt. % and a SiO₂ content of 55 to 65 wt. %, preferably 58 to 64 wt. %, particularly preferably 60 to 62.5 wt. %. Furthermore, preferred types of talc are characterised by an Al₂O₃ content of <5 wt. %, particularly preferably <1 wt. % and in particular <0.7 wt. %.

The use of talc in the form of finely milled types with an average largest particle size d₅₀ of <10 μm, preferably <5 μm, particularly preferably <2.5 μm, very particularly preferably ≦1.5 μm is particularly advantageous.

The expression very finely divided particles, in the context of the invention, is understood to mean particles with a particle size of 0.01 to 200 nm, preferably ≦50 nm and in particular ≦20 nm. The materials are preferably present as nanoscale particles.

Particle sizes and particle diameters in the context of this invention mean the average particle diameter d₅₀, determined by ultracentrifuge measurements as described by W. Scholtan et al., in Kolloid-Z. und Z. Polymere 250 (1972), p. 782-796.

Furthermore, the mineral particles may be surface-modified with organic molecules, for example silanised, in order to produce better compatibility with the polymers. Hydrophobic or hydrophilic surfaces may be produced in this way.

Particularly suitable very finely divided mineral particles with anisotropic particle geometry for use in the composition according to the invention are also the inorganic materials described in U.S. Pat. No. 5,714,537 and U.S. Pat. No. 5,091,461.

These materials are talc, clay or a material of a similar type which has a number average particle size of ≦10 μm and a ratio of average diameter to thickness (D/T) of 4 to 30. Several grades of talk and clay filler materials have turned out to be particularly suitable.

As described in U.S. Pat. No. 5,091,461, oval or plate-shaped materials with the given small particles are particularly suitable, rather than fibril-shaped or spherical fillers. Those compositions which contain particles which have a ratio of average diameter to thickness (D/T), measured in the way described in U.S. Pat. No. 5,714,537, of at least 4, preferably at least 6, more preferably at least 7, are highly preferred. With regard to the maximum value for the ratio D/T, it has been found desirable to have a value of up to and including 30, preferably up to and including 24, more preferably up to and including 18, still more preferably up to and including 13 and most preferably up to and including 10.

Mineral particles which are preferably used are known minerals, grades of talc and grades of clay. Particularly preferred are non-calcined grades of talcum and clays which have a very low concentration of free metal oxide. Grades of talc and grades of clay are generally known fillers for various polymeric resins. These materials and their suitability as fillers for polymeric resins are described in general terms in U.S. Pat. No. 5,091,461, U.S. Pat. No. 3,424,703 and EP-A 391 413.

The most suitable grades of the mineral talc are hydrated magnesium silicates such as those represented by the theoretical formula

3MgO.4SiO₂.H₂O

The compositions of the grades of talc may vary somewhat with the location where they are mined. For example, grades of talc from Montana correspond, by and large, to this theoretical composition. Suitable grades of the mineral talc of this type are commercially available as Mikrotalk MP 25-38 and Mikrotalk MP 10-52 from Pfizer.

The most suitable grades of clay are water-containing compounds of the aluminosilicate type, which are generally represented by the formula:

Al₂O₃.SiO₂.2H₂O

Suitable clay materials are commercially available as clays of the type Tex 10R from the Anglo American Clay Co.

These mineral particles preferably have a number average particle size, measured with a Coulter counter, of less than or equal to 10 micron (μm), more preferably less than or equal to 2 μm, still more preferably less than or equal to 1.5 μm and most preferably less than or equal to 1.0 μm. Depending on the type of milling or preparation, these types of fillers may have number average particle sizes of at least 0.05 μm, preferably at least 0.1 μm and more preferably at least 0.5 μm. The smaller particle sizes, if obtainable, may generally be used to advantage, but it has turned out to be difficult to obtain fillers of this type commercially with an average particle size of less than 1.5 μm.

Furthermore, these mineral particles generally have a maximum particle size of less than or equal to 50 μm, preferably less than or equal to 30 μm, more preferably less than or equal to 25 μm, still more preferably less than or equal to 20 μm and most preferably less than or equal to 15 μm.

Another way of specifying the desired uniformly small particle sizes and particle size distribution of the mineral particles which are preferably used in practical performance of the present invention comprises the data that at least 98 wt. %, preferably at least 99 wt. %, of the particles thereof in the final mixture have an equivalent spherical volume diameter of less than 44 μm, preferably less than 20 μm. The percentage by weight of filler particles with such diameters can also be measured by particle size analysis using a Coulter counter.

The mineral particles may be present as powders, pastes, sols, dispersions or suspensions. Powders are obtained by precipitation from dispersions, sols or suspensions.

The materials can be incorporated into the thermoplastic moulding compositions by conventional processes, for example by direct compounding or extruding of moulding compositions and the very finely divided inorganic powders. Preferred processes are the preparation of a masterbatch, e.g. in flame retarding additives and at least one component of the moulding compositions according to the invention in monomers or solvents, or the co-precipitation of a thermoplastic component and the very finely divided inorganic powders, e.g. by co-precipitation of an aqueous emulsion and the very finely divided inorganic powders, optionally in the form of dispersions, suspensions, pastes or sols of the very finely divided inorganic materials.

Examples of substances which can preferably be used as mineral particles according to the invention are Tremin® 939-300EST from Quarzwerke GmbH, Frechen, Germany (aminosilane-coated wollastonite with an average needle diameter of 3 μm), Finntalc® M30SL from Omya GmbH, Cologne, Germany (uncoated talc with a particle size d₅₀=8.5 μm), Wicroll® 40 PA from Omya GmbH, Cologne, Germany (silanised wollastonite with a particle size d₅₀=1.3 μm) and Burgess® 2211 from Omya GmbH, Cologne, Germany (aminosilane-coated aluminium silicate with a particle size d₅₀=1.3 μm).

The mineral particles in component E may be present in the composition according to the invention in an amount of preferably 0.1 to 50 wt. %, particularly preferably 0.2 to 20 wt. % and in a most preferred manner 0.5 to 15 wt. %, with respect to the weight of the composition.

Component F

Polymer compositions according to the invention may contain conventional additives such as flame retardants, anti-drip agents, very finely divided inorganic compounds, lubricants and mould release agents, nucleating agents, antistatic agents, stabilisers, fillers and reinforcing agents as well as colorants and pigments.

Compositions according to the invention may generally contain 0.01 to 20 wt. %, with respect to the total composition, of flame retardants. Examples of flame retardants which may be mentioned are organic halogen compounds such as decabromobisphenyl ether, tetrabromobisphenol, inorganic halogen compounds such as ammonium bromide, nitrogen compounds such as melamine, melamine/formaldehyde resins, inorganic hydroxide compounds such as Mg—Al hydroxide, inorganic compounds such as aluminium oxides, titanium dioxides, antimony oxides, barium metaborate, hydroxyantimonate, zirconium oxide, zirconium hydroxide, molybdenum oxide, ammonium molybdate, tin borate, ammonium borate and tin oxide as well as siloxane compounds.

Furthermore phosphorus compounds, such as those described in EP-A 363 608, EP-A 345 522 and/or EP-A 640 655, may be used as flame retardant compounds.

Suitable further filler and reinforcing materials are those which differ from component E). For example, glass fibres, optionally cut up or milled, glass pearls, glass beads, kaolins, talcs, mica, silicates, quartz, talcum, titanium dioxide, wollastonite, mica, carbon fibres or mixtures of these are suitable. Glass fibres which have been cut up or milled are preferably used as a reinforcing material. Preferred fillers, which may also act in a reinforcing manner, are glass beads, mica, silicates, quartz, talcum, titanium dioxide, wollastonite.

The sum of the percentages by weight of all the constituents in the compositions is 100.

Compositions according to the invention are prepared by blending the relevant constituents in a known manner and melt-compounding and melt-extruding at temperatures of 200° C. to 300° C. in conventional equipment such as internal compounders, extruders and twin-shaft screws, wherein the mould release agent is used in the form of a coagulated mixture.

Blending of the individual constituents may take place in a known manner either in sequence or else simultaneously, to be precise either at 20° C. (room temperature) or else at a higher temperature.

Polymer compositions according to the invention may be used to produce moulded items of any type. In particular, moulded items are produced by injection moulding. Examples of moulded items are: housing parts of any type, for example for domestic appliances such as electric razors, flat screens, monitors, printers, copiers or covering sheets for the building industry and parts for motor vehicles and railway vehicles. They can also be used in the field of electrical engineering, because they have very good electrical properties.

Furthermore, polymer compositions according to the invention may be used, for example, to produce the following moulded items or moulded parts:

internal structural parts for railway vehicles, ships, buses, other motor vehicles and aircraft, hub-caps, housings for electrical appliances which contain small transformers, housings for equipment for information dissemination and transfer, flat wall elements, housings for safety devices, rear spoilers and other body parts for motor vehicles, thermally insulated transport containers, devices for retaining or caring for small animals, grids for covering ventilator openings, moulded parts for summer houses and garden sheds, housings for garden equipment.

Another form of processing is the production of moulded items by thermoforming from previously produced sheets or films.

The present invention therefore also provides the use of compositions according to the invention to produce moulded items of any type at all, preferably those mentioned above, and also moulded items made from the compositions according to the invention.

The following examples are used to explain the invention in more detail.

### EXAMPLES

In accordance with the data in table 1, five polyamide compositions were prepared, processed to give specimen items and tested.

Component A

Polyamide (Durethan® B30 from Bayer AG, Germany).

Component B

Graft polymer of 40 parts by wt. of a copolymer of styrene and acrylonitrile in the ratio 73:27 on 60 parts by wt. of particulate cross-linked polybutadiene rubber (average particle diameter d₅₀=0.28 μm), prepared by emulsion polymerisation.

Component C

Terpolymer of styrene and acrylonitrile in the ratio by weight of 2.1:1, containing 1 mol % of maleic anhydride.

Component D

Styrene/acrylonitrile copolymer with a styrene/acrylonitrile ratio by weight of 72:28 and an intrinsic viscosity of 0.55 dl/g (measured in dimethylformamide at 20° C.).

Component E1

Aminosilane-coated wollastonite with an average needle diameter of d₅₀=8 μm (Tremin® 939-300EST from Quarzwerke GmbH, Frechen, Germany).

Component E2

Aminosilane-coated aluminium silicate with a particle size d₅₀ 1.4 μm (Burgess® 2211 from Omya GmbH, Cologne, Germany).

Component E3

Silanised wollastonite with a particle size d₅₀=13 μm (Wicroll® 40PA from Omya GmbH, Cologne, Germany).

Component E4

Uncoated talc with a particle size d₅₀=8.5 μm (Finntalc® M30SL from Omya GmbH, Cologne, Germany).

Component F

Additives

TABLE 1

| Composition | | | | | |
|---|---|---|---|---|---|
| [parts by wt.] | 1 (comp.) | 2 | 3 | 4 | 5 |
| A (polyamide) | 44 | 44 | 44 | 44 | 44 |
| B (graft polymer) | 33 | 33 | 33 | 33 | 33 |
| C (compatibility | 6 | 6 | 6 | 6 | 6 |
| promoter) | | | | | |
| D (vinyl copolymer) | 17 | 17 | 17 | 17 | 17 |
| E1 (mineral particles) | — | 8 | — | — | — |
| E2 (mineral particles) | — | — | 8 | — | — |
| E3 (mineral particles) | — | — | — | 8 | — |
| E4 (mineral particles) | — | — | — | — | 8 |
| F (additives) | 1.5 | 1.5 | 1.5 | 1.5 | 1.5 |

Preparing and Testing the Moulding Compositions According to the Invention

Mixing the components in the compositions takes place in a 3 1 internal compounder. The moulded items are produced on an injection moulding machine of the type Arburg 270 E at 260° C.

The Vicat B thermal resistance is determined in accordance with DIN 53 460 (ISO 306) using rods with the dimensions 80×10×4 mm.

The melt volume rate (MVR) is determined in accordance with ISO 1133 at 240° C. using a plunger load of 5 kg.

The tensile strength and elongation at break are determined in accordance with DIN 53457/ISO 527.

The linear coefficient of expansion (pm×K⁻¹) is determined in accordance with ASTM E 831.

The results of the individual tests are summarised in table 2.

TABLE 2

| Composition | 1 (comp.) | 2 | 3 | 4 | 5 |
|---|---|---|---|---|---|
| Vicat B (° C.) | 103 | 108 | — | — | — |
| Melt volume rate | 4 | — | 3 | 4 | 3 |
| (cm³/10 min) | | | | | |
| Tensile strength (mPa) | 1850 | — | 2030 | 2300 | 2554 |
| Elongation at break (%) | 90 | — | 120 | 60 | 80 |
| Linear coefficient of | 118 | 74 | 93 | 82 | 63 |
| expansion (pm × K⁻¹) | | | | | |

The results given in table 2 show that samples 2 to 5 according to the invention have an improved tensile strength and elongation at break and also a considerably improved thermal resistance, expressed by the coefficient of expansion, with unaltered good thermal resistance and melt viscosity as compared with comparison example 1 which does not contain any very fine mineral particles with anisotropic particle geometry.

1. A polymer composition containing
(A) at least one polyamide,
(B) at least one graft copolymer, wherein the graft substrate is based on a diene rubber,
(C) at least one compatibility promoter,
(D) at least one vinyl copolymer, and
(E) very finely divided mineral particles with anisotropic particle geometry.

2. A composition according to claim 1, wherein polyamide A is present in an amount of 10 to 98 wt. %, with respect to the composition.

3. A composition according to claim 1, wherein polyamide A is present in an amount of 15 to 70 wt. %, with respect to the composition.

4. A composition according to claim 1, wherein polyamide A is present in an amount of 20 to 60 wt. %, with respect to the composition.

5. A composition according to claim 1 to 4, wherein component B is a graft polymer of
B.1 50 to 99 wt. % of one or more vinyl monomers on
B.2 50 to 1 wt. % of one or more graft substrates based on a diene rubber, which may contain further copolymerisable vinyl monomers, with a glass transition temperature <10° C.

6. A composition according to claim 5, wherein vinyl monomer B.1 is a mixture of
B.1.1 styrene, α-methylstyrene, halogen or alkyl ring-substituted styrenes and/or C₁-C₈-alkyl (meth)acrylates and
B.1.2 unsaturated nitrites, C₁-C₈-alkyl (meth)acrylates and/or derivatives of unsaturated carboxylic acids.

7. A composition according to one of the preceding claims, wherein the graft substrate B.2 is a polybutadiene which may contain up to 30 wt. % (with respect to the graft substrate) of other monomers chosen from at least one of the group styrene, α-methylstyrene, acrylonitrile and methyl methacrylate.

8. A composition according to one of the preceding claims, wherein graft polymer B is present in an amount of 0.5 to 80 wt. %, with respect to the composition.

9. A composition according to one of the preceding claims, wherein graft polymer B is present in an amount of 1 to 60 wt. %, with respect to the composition.

10. A composition according to one of the preceding claims, wherein component C contains at least (a) a vinyl aromatic monomer chosen from the group C₂-C₁₂-alkyl (meth)acrylates, methacrylonitrile and acrylonitrile and (b) dicarboxylic anhydrides containing α,β-unsaturated components.

11. A composition according to one of the preceding claims, wherein component C is present in an amount of 0.5 to 50 wt. %, with respect to the composition.

12. A composition according to one of the preceding claims, wherein component C is present in an amount of 1 to 30 wt. %, with respect to the composition.

13. A composition according to one of the preceding claims, wherein component C is present in an amount of 2 to 10 wt. %, with respect to the composition.

14. A composition according to one of the preceding claims, wherein component D consists of vinyl (co)polymers of at least one monomer from the group of vinyl aromatic compounds, vinyl cyanides, C₁-C₈-alkyl (meth)acrylates, unsaturated carboxylic acids and derivatives of unsaturated carboxylic acids.

15. A composition according to one of the preceding claims, wherein component D is present in an amount of 0 to 80 wt. %, with respect to the composition.

16. A composition according to one of the preceding claims, wherein component D is present in an amount of 0 to 70 wt. %, with respect to the composition.

17. A composition according to one of the preceding claims, wherein component E contains very finely divided mineral particles with an aspect ratio greater than 2.

18. A composition according to one of the preceding claims, wherein component E contains mineral particles which have a number average particle size, measured by a Coulter counter, of ≦10 μm and a ratio of average diameter to thickness (D/T) of 4 to 30.

19. A composition according to one of the preceding claims, wherein at least 98 wt. % of the particles contained in component E have an equivalent spherical volume diameter of less than 44 μm, measured by a Coulter counter.

20. A composition according to one of the preceding claims, wherein component E contains mineral oval or plate-shaped particles.

21. A composition according to one claims 17 to 20, wherein the mineral particles are chosen from the group consisting of talc, wollastonite and aluminium silicate.

22. A composition according to one of the preceding claims, wherein component E is present in an amount of 0.1 to 50 wt. %, with respect to the composition.

23. A composition according to one of the preceding claims, wherein component E is present in an amount of 0.2 to 20 wt. %, with respect to the composition.

24. A composition according to one of the preceding claims, wherein at least one additive chosen from the group of lubricants and mould release agents, nucleating agents, antistatic agents, stabilisers, colorants and pigments is present as further component F.

25. A composition according to one of the preceding claims, containing a flame retardant.

26. Use of the polymer composition according to one of claims 1 to 25 to produce moulded items.

27. Moulded items obtainable from a polymer composition according to one of claims 1 to 25.

28. Moulded items according to claim 27, wherein the moulded item is part of a motor vehicle, railway vehicle, aircraft or water vehicle.

29. Housing parts, covering sheets and parts for the motor vehicle sector, obtainable from polymer compositions according to one of claims 1 to 25.
